(19) United States
(12) Patent Application Publication
(10) Pub. No.: US 2007/0104339 A1
(43) Pub. Date: May 10, 2007

(54) Electret condenser microphone

(75) Inventors: Toshiro Izuchi, Kurate-gun (JP); Kensuke Nakanishi, Kurate-gun (JP); Ryuji Awamura, Kurate-gun (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Hosiden Corporation, Osaka (JP)

(21) Appl. No.: 11/588,035

(22) Filed: Oct. 25, 2006

(30) Foreign Application Priority Data
Nov. 4, 2005 (JP) 2005-320815

(51) Int. Cl. H04R 25/00; H04R 17/02

(52) U.S. Cl. 381/174; 381/369

(57) ABSTRACT

An object of the present invention is to provide a digital-output electret condenser microphone capable of being soldered on a wiring substrate of an apparatus by using a reflow furnace. An electret condenser microphone according to the present invention has an electret polymer film and a spacer that are formed of a heat-resistant material. Sound apertures are provided in a front panel of the electrically conductive capsule and/or the wiring substrate. Provided on the surface exposed in the open end of the electrically conductive capsule are multiple terminals, including at least a power supply terminal, a digital signal output terminal, and a clock input terminal. The terminals are protruded outward beyond a caulked part at the open end of the electrically conductive capsule.

### TECHNICAL FIELD

The present invention relates to an electret condenser microphone used in apparatuses such as cellular phones, video cameras, and personal computers.

### BACKGROUND ART

When an electronic component is to be mounted onto a wiring substrate, an automatic soldering apparatus called a reflow furnace is used to solder terminals of the component to pads provided on the wiring substrate. In the reflow furnace, the wiring substrate on which the component is disposed is passed over melted solder. While the wiring substrate is passing, a portion of the melted solder is brought into contact with the pads provided on the wiring substrate and the terminals of the component, thereby soldering the terminals of the component to the pads on the wiring substrate. Accordingly, the component is exposed to a high melting temperature (approximately 260° C.) of the solder for a brief moment.

An electret condenser microphone converts an acoustic wave into an electric signal by using a polarized electret polymer film as an acoustic-electric conversion element (Japanese Utility Model Application Laid Open No. 5(1993)-23698) (Reference 1). The electret polymer film is typically a FEP (Fluoro Ethylene Propylene) film. However, FEP films have heat resistances on the order of 150° C. at the highest and are easily affected by heat. Electret condenser microphones therefore have not been capable of being soldered onto a wiring substrate using a reflow furnace.

The following methods have been conventionally used for mounting an electret condenser microphone onto a wiring substrate. In a first method, leads are connected to the terminals of an electret condenser microphone beforehand and the leads are used to electrically connect the terminals of the electret condenser microphone to pads on a wiring substrate to mount it on the wiring substrate. In a second method, a microphone holder is provided and an electrically conductive spring held by the microphone holder is used to electrically connect the terminals of an electret condenser microphone onto pads on a wiring substrate.

Conventional electret condenser microphones outputs analog signals. Such a conventional electret condenser microphone requires two terminals: a power supply terminal and an analog output terminal. Therefore, the microphone can be relatively readily connected by using leads or springs.

However, electret condenser microphones that output digital signals have been proposed recently (International Publication No. WO 2003/075603 Pamphlet) (Reference 2). FIG. 1 shows an exemplary internal configuration of electric circuitry of such an electret condenser microphone. A digital-output electret condenser microphone is composed of an acoustic-electric transducer 90 and an IC device 10 that are contained in an electrically conductive capsule 1. The acoustic-electric transducer 90, as well known, uses a combination of a diaphragm and an electret polymer film to convert sound to an electric signal. Integrated in the IC device 10 are an amplifier 10A, which also functions as an impedance converter, and a digital sigma modulator 10B having an A/D conversion capability. The IC device 10 requires a power supply terminal S1, a clock input terminal S2, a digital data output terminal S3, and a common potential terminal S4. The digital-output electret condenser microphone therefore requires at least four terminals.

Because a digital-output electret condenser microphone has twice as many terminals as an analog-output electret condenser microphone, using leads or electrically conductive springs to electrically connect the components of the digital-output electret condenser microphone to a wiring substrate requires much implementation time and complexity.

Furthermore, the terminals of an electret condenser microphone are formed on a surface of a wiring substrate caulked on an open end of an electrically conductive capsule. Because the terminals of conventional electret condenser microphones are electrically connected onto a wiring substrate of an apparatus using leads or electrically conductive springs, a height of the terminals of the electret condenser microphone that is lower than that of the caulked part of the electrically conductive capsule has presented no problem. However, if the electret condenser microphone is to be mounted onto a wiring substrate of an apparatus by using a reflow furnace, the terminals of the electret condenser microphone that are lower in height than the caulked part of the electrically conductive capsule do not come into contact with pads on the wiring substrate of the apparatus. This means that the terminals cannot be soldered to the pads in a reflow furnace.

FIG. 2 shows an exemplary structure of terminals and a caulked part of an electrically conductive capsule of a conventional electret condenser microphone. Reference numeral 1 in FIG. 2 denotes an electrically conductive capsule, 2 denotes a wiring substrate caulked on an open end of the electrically conductive capsule 1, 3 denotes the caulked part, and 4 denotes terminals formed on an exterior surface of the wiring substrate 2. The electrically conductive capsule 1 is made of an electrically conductive plate material which is relatively thick. The terminals 4 are made of a copper foil thinner than the electrically conductive plate material of the electrically conductive capsule 1. Symbol “t” in FIG. 2 denotes the difference in height between the top face of the calked part of the electrically conductive capsule 1 and the top face of the terminals 4. If the height of the terminals 4 is lower than that of the caulked part 3, the terminals 4 cannot be soldered onto the wiring substrate of an apparatus (not shown) by using a reflow furnace.

### DISCLOSURE OF THE INVENTION

An object of the present invention is to provide a digital-output electret condenser microphone capable of being soldered on a wiring substrate of an apparatus by using a reflow furnace.

An electret condenser microphone according to the present invention is enclosed in an electrically conductive cylindrical capsule having one end that is closed by a front panel and the other end that is open. The opening is closed by a wiring substrate having a surface on which an IC device is provided and another surface on which terminals are provided. Provided in the space between the front panel and the wiring substrate are an electrically conductive diaphragm and the front panel or a fixed electrode spaced a predetermined distance apart from each other by a spacer. One of the surfaces opposing each other across the spacer is covered with an electret polymer film. The electret polymer film and the spacer are made of a heat-resistant material. Sound apertures are formed in the front panel of the electrically conductive capsule and/or the wiring substrate.

A cylindrical heat-resistant-resin member may be provided between the inner periphery surface of the electrically conductive capsule and components enclosed in the electrically conductive capsule. The wiring substrate is double-sided. Provided on the surface of wiring substrate that is exposed in the opening of the electrically conductive capsule are multiple terminals, including at least a power supply terminal, a digital signal output terminal, and a clock input terminal. The terminals are protruded outward beyond the caulked part of the opening of the electrically conductive capsule.

Because the electret polymer film and the spacer of the electret condenser microphone of the present invention are made of a heat-resistive material, the heat resistance of the whole microphone is improved. Therefore, a reflow furnace can be used for mounting the microphone onto a wiring substrate. The terminals of the electret condenser microphone can be protruded outward beyond the caulked part of the electrically conductive capsule. Therefore, the terminals can be brought into contact with pads on a wiring substrate of an apparatus with electret condenser microphone being placed on the wiring substrate of the apparatus. Consequently, a reflow furnace can be used to solder the electret condenser microphone onto the wiring substrate of the apparatus. Thus, a digital-output electret condenser microphone having many terminals can be mounted on a wiring substrate in a simplified manner.

### BRIEF DESCRIPTION OF THE DRAWINGS

FIG. 1 shows an electric configuration of a digital-signal-output electret condenser microphone;

FIG. 2 is a partial cross-sectional view of a conventional electret condenser microphone for illustrating a disadvantage of the conventional art;

FIG. 3 is an enlarged cross-sectional view of an exemplary front-type electret condenser microphone to which the present invention is applied;

FIG. 4 is a perspective view of a terminal used in the front-type electret condenser microphone shown in FIG. 3;

FIG. 5A is an exploded perspective view of components of the front-type electret condenser microphone shown in FIG. 3, viewed from a front-panel side;

FIG. 5B is an exploded perspective view of components of the front-type electret condenser microphone shown in FIG. 3, viewed from a wiring-substrate side;

FIG. 6 is an enlarged cross-sectional view of an exemplary back-type or foil-type electret condenser microphone to which the present invention is applied;

FIG. 7A is an exploded perspective view of components of the back-type or foil-type electret condenser microphone shown in FIG. 6, viewed from a front-panel side;

FIG. 7B is an exploded perspective view of components of the back-type or foil-type electret condenser microphone shown in FIG. 6, viewed from a wiring-substrate side;

FIG. 8A is an exploded perspective view of components including a metallic mesh of the back-type or foil-type electret condenser microphone shown in FIG. 6, viewed from a front-plate side;

FIG. 8B is an exploded perspective view of components including a metallic mesh of the back-type or foil-type electret condenser microphone shown in FIG. 6, viewed from a wiring-substrate side;

FIG. 9 is an enlarged cross-sectional view of a reverse-type electret condenser microphone to which the present invention is applied;

FIG. 10A is an exploded perspective view of components of the reverse-type electret condenser microphone shown in FIG. 9, viewed from a front-panel side;

FIG. 10B is an exploded perspective view of components of the reverse-type electret condenser microphone shown in FIG. 9, viewed from a wiring-substrate side;

FIG. 11 is a cross-sectional view of a front-type electret condenser microphone having sound apertures in its wiring substrate;

FIG. 12 is a cross-sectional view of a front-type electret condenser microphone having sound apertures in its front panel and wiring substrate;

FIG. 13 is a perspective view of an example in which disc-shaped pads are used as terminals;

FIG. 14 is a perspective view of an example in which an ancillary substrate is superimposed on a wiring substrate;

FIG. 15 is a perspective view of another example in which an ancillary substrate is superimposed on a wiring substrate;

FIG. 16 is a cross-sectional view illustrating a method for forming terminals by etching; and

FIG. 17 is a cross-sectional view illustrating a method for forming terminals by plating.

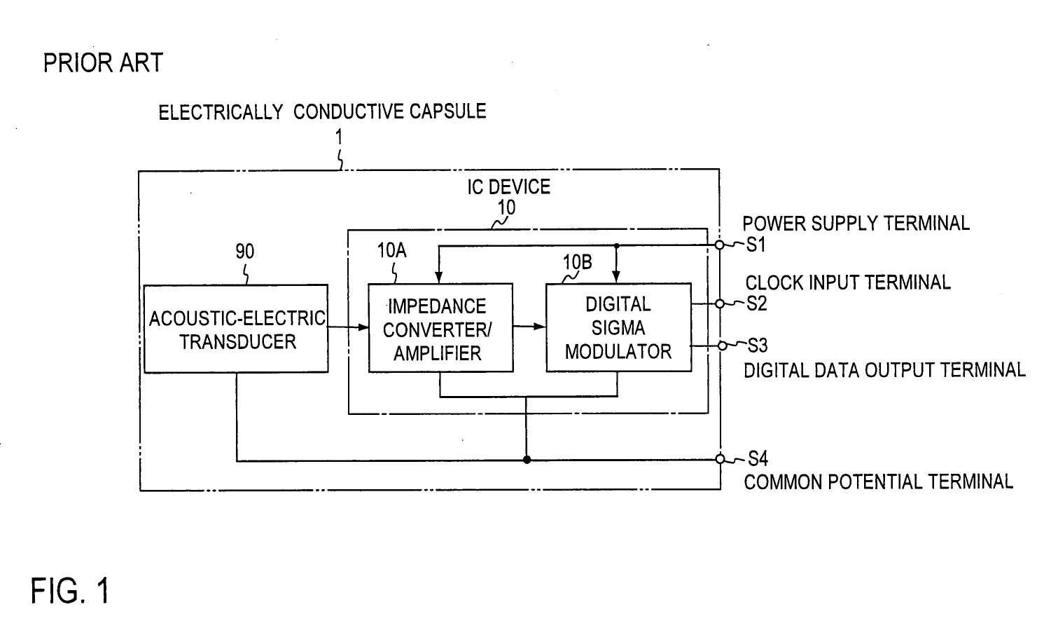

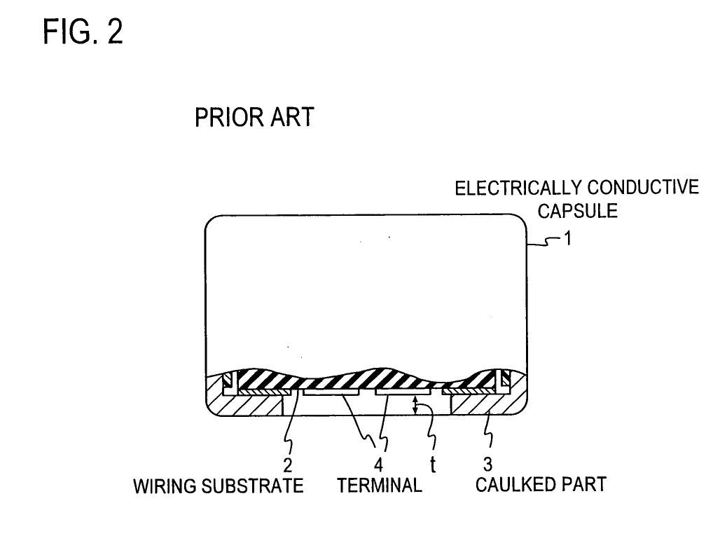

### BEST MODES FOR CARRYING OUT THE INVENTION

In a front-type electret condenser microphone, an electret polymer film that covers inner surface of a front panel of its electrically conductive capsule and a spacer in contact with the electret polymer film are made of a heat-resistant material. Using a heat-resistant material improves the heat resistance of the front-type condenser microphone unit.

In the case of back-type, foil-type, and reverse-type electret condenser microphones, a cylindrical synthetic-resin molded member provided on the inner surface of the electrically conductive capsule is made of a heat-resistant material. In addition, an electret polymer film that covers one of a diaphragm and a fixed electrode, and a spacer are also made of a heart-resistant material. Using heat-resistant materials in this way increases the heat resistance of the back-type, foil-type, and reverse-type condenser microphone unit.

### First Embodiment

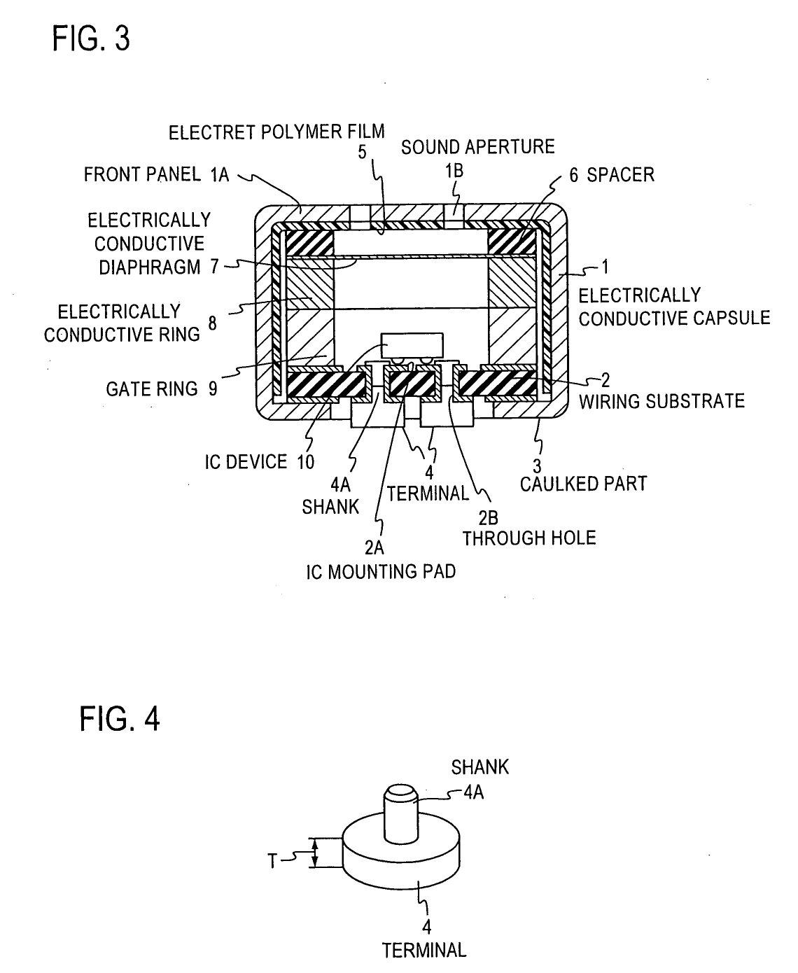

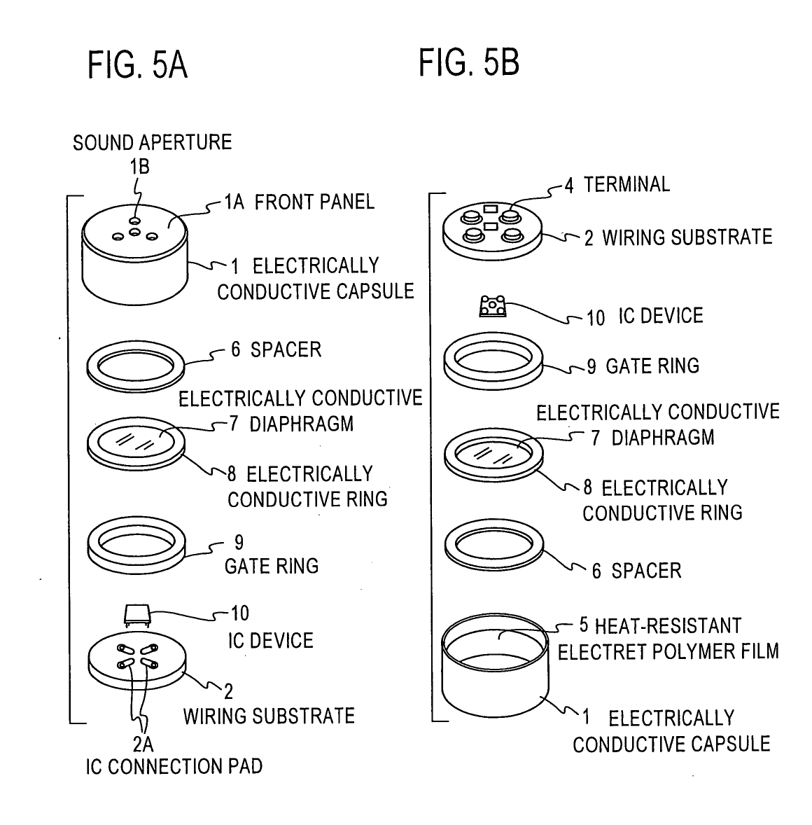

FIGS. 3 to 5 show an exemplary front-type electret condenser microphone to which the present invention has been applied. FIG. 3 is a cross-sectional view of the completed front-type electret condenser microphone, FIG. 4 is a perspective view of an exemplary structure of a terminal to be mounted to a wiring substrate 2, and FIGS. 5A and 5B are exploded perspective view of components of the front-type electret condenser shown in FIG. 3.

An electrically conductive capsule 1 is a cylinder having one end closed by a front panel 1A and the other end being open as shown in FIGS. 5A and 5B. While the capsule shown has a cylindrical shape, the shape of the capsule is not so limited. The front panel 1A has sound apertures 1B through which an acoustic wave is captured into the electrically conductive capsule 1. In the case of front-type electret condenser microphones, at least the inner surface of the front panel 1A of the electrically conductive capsule 1 is covered with an electret polymer film 5. In this embodiment, the inner surface of the whole electrically-conductive capsule 1 as well as that of the front panel 1A is covered with an electret polymer film 5. The electret polymer film 5 that so covers them functions as a cylindrical synthetic-resin molded member that insulates the components from the electrically conductive capsule 1.

As shown in FIGS. 5A and 5B, placed in the electrically conductive capsule 1 are an insulating spacer 6, an electrically conductive diaphragm 7, an electrically conductive gate ring 9, and a wiring substrate 2, in this order. The open end of the electrically conductive capsule 1 is folded toward the wiring substrate 2 and caulked to fix the components in the electrically conductive capsule 1 with a wiring substrate 2 being placed in the capsule 1. The electrically conductive diaphragm 7 is electrically connected to a sound signal input terminal on the wiring substrate 2 through the electrically conductive ring 8 and the gate ring 9. The front panel 1A of the electrically conductive capsule 1 functions as a fixed electrode with a common electric potential.

The electrically conductive diaphragm 7 is held by the electrically conductive ring 8 at its rim under tension exerted by the electrically conductive ring 8. Provided on the inner surface of the wiring substrate 2 are IC mounting pads 2A, on which an IC device 10 is to be mounted.

Features of the present invention are that the electret polymer film 5 that covers the inner surface of the electrically conductive capsule 1 and the spacer 6 are made of a heat-resistant material or materials and that the terminal 4 mounted on the wiring substrate 2 is thicker than the plate thickness of the electrically conductive capsule 1. The heat-resistant electret polymer film can be obtained by polarizing a PTFE (polytetrafluoroethylene) film in the direction of the thickness of the film. The heat-resistant material can resist temperatures of the order of 260-300° C. and therefore the temperatures in the reflow furnace.

The electret polymer film 5 can be formed as described in Reference 1 by following the process described below, for example. A heat-resistant polymer film (for example PTFE film) is deposited to a thickness in the range of 12.5 to 25.0 μm on one surface of a aluminum plate having a thickness in the range of 0.3 to 0.35 mm by continuous thermal deposition. The plate is then shaped into the shape of the inner surface of the electrically conductive capsule 1 with the surface covered with the polymer film facing inward (being nearer to the center of the cylinder). A width of approximately 0.8 mm of the polymer film at its edge is peeled away from the plate to expose the surface of the aluminum. Common sound apertures 1B are formed in the front panel 1A of the electrically conductive capsule 1 and the polymer film. Electron beam polarization is applied to the portion of the polymer film that covers the front panel 1A of the electrically conductive capsule 1.

According to the present invention, the spacer is made of a heat-resistant material. The spacer 6 is provided for holding the electret polymer film 5 and the electrically conductive diaphragm 7 at a given distance from each other. During a reflow process, the electrically conductive capsule 1 is heated to high temperatures and so is the spacer 6. If the spacer 6 were not heat-resistant, the thickness of the spacer 6 would be changed by the heat and the given distance between the electret polymer film 5 and the electrically conductive diaphragm 7 cannot be maintained. Under such conditions, desired characteristics cannot be obtained. Degradation of characteristics during soldering in a reflow furnace can be prevented by choosing a heat-resistant material, such as polyimide resin, as the material of the spacer 6.

A structure of the terminal 4, which is another feature of the present invention, will be described next. As shown in FIG. 4, the terminal 4 has a shank 4A in the center on one surface of its disc portion. As shown in FIG. 3, the wiring substrate 2 is double-sided and the shaft 4A is engaged in a through hole 2B in the wiring substrate 2. The through hole 2B is filled with solder so that the shank 4A is soldered to a metallic conductor constituting the through hole 2B.

The thickness T of the disc portion of the terminal 4 (see FIG. 4) is made thicker than the conductive plate forming the electrically conductive capsule 1. Choosing such an appropriate thickness T ensures that the terminal 4 protrudes outward beyond the caulked part 3 of the electrically conductive capsule 1 even though the open end of the electrically conductive capsule 1 is caulked onto the wiring substrate 2 as shown in FIG. 3. Thus, when the electret condenser microphone according to the present invention is placed on the surface of a wiring substrate of an apparatus, the terminal 4 is placed on and brought into contact with an appropriate wiring conductor formed on the wiring substrate of the apparatus to be soldered automatically by using the reflow furnace.

### Second Embodiment

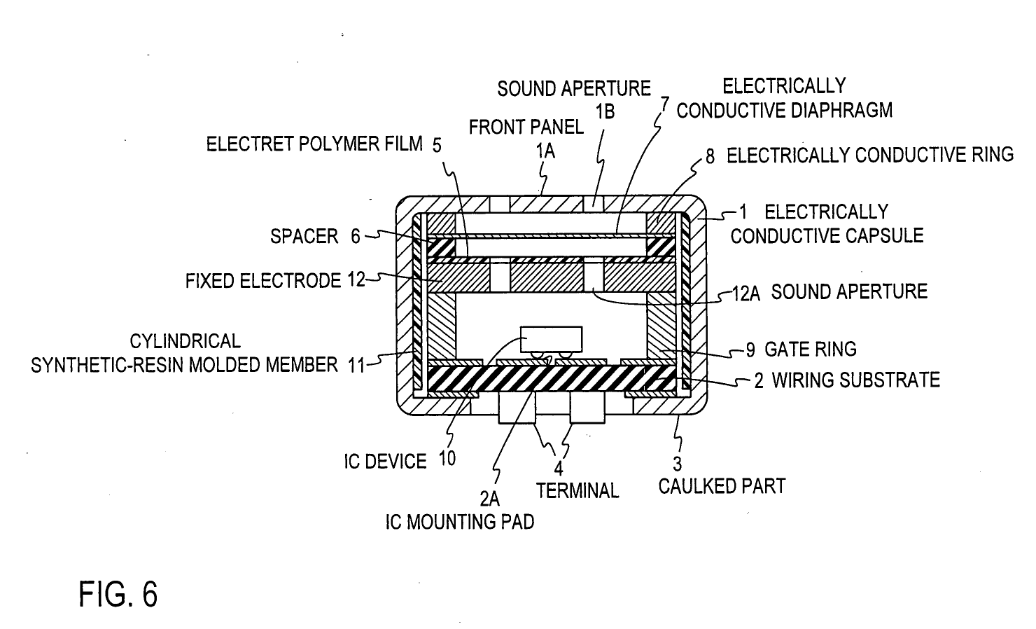

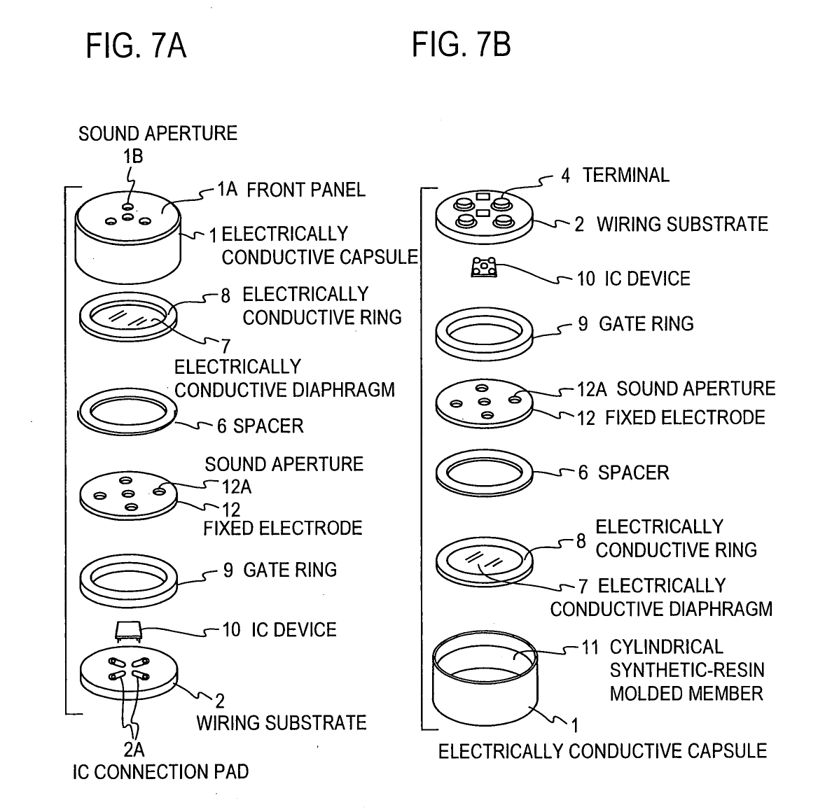

FIG. 6 shows an exemplary back-type or file-type electret condenser microphone to which the present invention has been applied. FIGS. 7A and 7B are exploded perspective views of components of the back-type or foil-type electret condenser microphone shown in FIG. 6. Provided in the back-type or foil-type electret condenser microphone are an electrically conductive diaphragm 7, an insulating spacer 6, and a fixed electrode 12 in this order from the front plate side of the electrically conductive capsule 1. Sound apertures 12A are formed in the fixed electrode 12 as well and the space between the fixed electrode 12 and a wiring substrate 2 is not sealed.

The back-type or foil-type electret condenser microphone has a cylindrical molded member 11 between the inner surface of the electrically conductive capsule 1 and the components. The cylindrical synthetic-resin molded member 11 insulates the fixed electrode 12 and a gate ring 9 from the electrically conductive capsule 1. The electrically conductive diaphragm 7 is held by an electrically conductive ring 8 at its rim under tension exerted by the electrically conductive ring 8. The electrically conductive diaphragm 7 is electrically connected to the electrically conductive capsule 1 through the electrically conductive ring 8 and is maintained at a common electric potential. The fixed electrode 12 is connected to a sound signal input terminal on a wiring substrate 2 through the gate ring 9.

In the second embodiment, one surface of one of the electrically conductive diaphragm 7 and the fixed electrode 12 is covered with an electret polymer film 5. In FIG. 6, one surface of the fixed electrode 12 (the surface facing the electrically conductive diaphragm 7) is covered with the film 5.

Also in the second embodiment, the electret polymer film 5, the spacer 6, and the cylindrical synthetic-resin molded member 11 are made of a heat-resistant material such as a polyimide resin, urethane resin, or PTFE. Using a heat-resistant material enables the structure in the electrically conductive capsule 1 to resist high temperatures of the order of 260° C. at minimum. Therefore, the electret condenser microphone can be mounted to a wiring substrate of an apparatus by using a reflow furnace.

As described with respect to FIGS. 3 and 4, the thickness T of the disc portion of a terminal 4 is made thicker than the capsule 1. This ensures that the terminal 4 protrudes outward beyond a caulked part 3 of the electrically conductive capsule 1. In this way, back-type and foil-type electret condenser microphones capable of being mounted on a wiring substrate of an apparatus by using a reflow furnace can be provided.

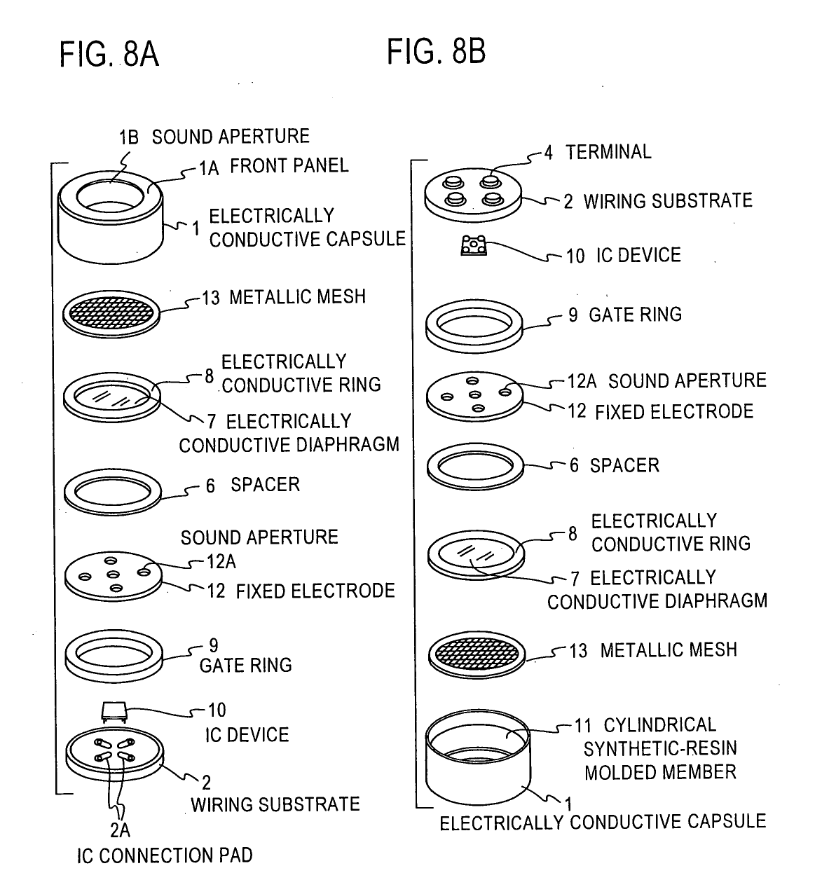

While a structure that does not have a metallic mesh 13 for protecting the electrically conductive diaphragm 7 is shown in FIGS. 6 and 7, a metallic mesh 13 can be provided anterior to the electrically conductive diaphragm 7 as shown in FIG. 8 in order to prevent any foreign matter from entering inside. If a metallic mesh 13 is to be provided in a front-type electret condenser microphone of the first embodiment, the metallic mesh 13 may be placed anterior to the front panel 1A of the electrically conductive capsule 1.

### Third Embodiment

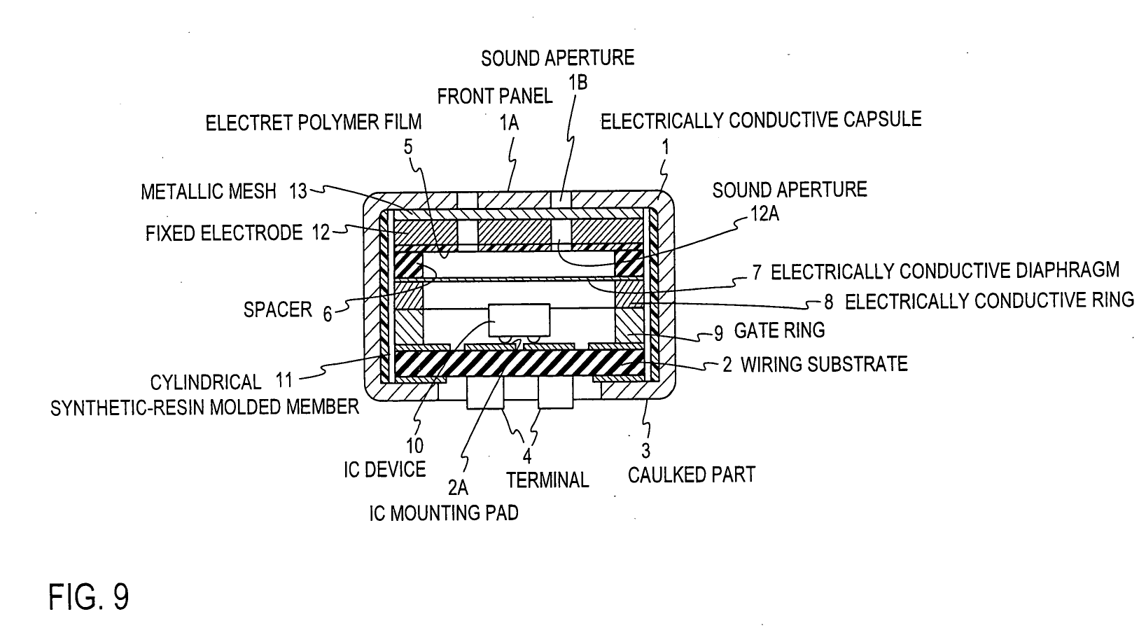

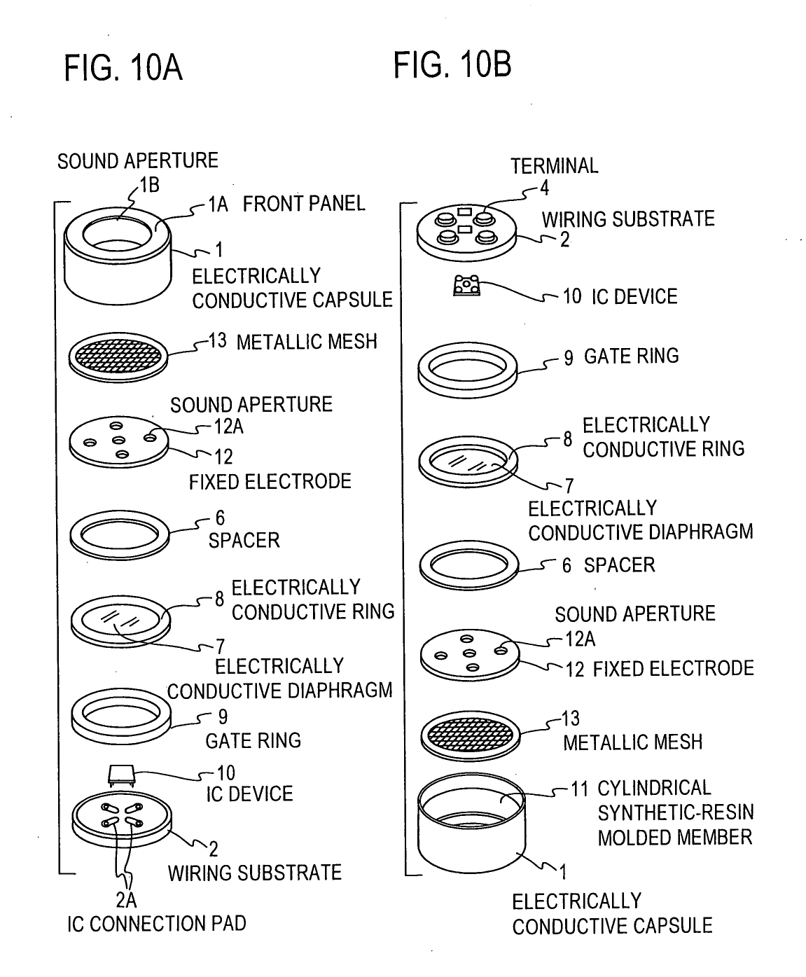

FIG. 9 shows a cross-sectional view of an exemplary reverse-type electret condenser microphone to which the present invention has been applied. FIG. 10A shows an exploded perspective view of components of the reverse-type electret condenser microphone shown in FIG. 9. Provided in the reverse-type electret condenser microphone are a fixed electrode 12, a spacer 6, and an electrically conductive diaphragm 7 in this order from the front panel side of the electrically conductive capsule 1. In the third embodiment, a metallic mesh 13 is provided between the fixed electrode 12 and the front panel 1A and the surface of the fixed electrode 12 that faces the electrically conductive diaphragm is covered with an electret polymer film 5 made of a heat-resistant material. The fixed electrode 12 and the electrically conductive diaphragm 7 are held at a given distance from each other by the thickness of the spacer 6. A cylindrical synthetic-resin molded member 11 attached to the inner peripheral surface of the electrically conductive capsule 1 insulates the electrically conductive diaphragm 7 and the gate ring 9 from the electrically conductive capsule 1. The electrically conductive diaphragm 7 is held by an electrically conductive ring 8 at its rim under tension exerted by the electrically conductive ring 8. The electrically conductive diaphragm 7 is electrically connected to a sound signal input terminal on a wiring substrate 2 through the electrically conductive ring 8 and the gate ring 9. The fixed electrode 12 is electrically connected to the electrically conductive capsule 1 through the metallic mesh 13 and is maintained at a common electric potential.

According to the present invention, the spacer 6 of the reverse-type electret condenser microphone in FIG. 9, the electrically conductive diaphragm 7, the electret polymer film 5, and the cylindrical synthetic-resin molded member 11 are made of a heat-resistant material such as a polyimide resin, urethane resin, or PTFE resin. By making the spacer 6, the electret polymer film 5, and the cylindrical synthetic-resin molded member 11 from a heat-resistant material, the reverse-type electret condenser microphone capable of enduring high temperatures of the order of 260° C. can be provided. The reverse-type electret condenser microphone therefore can be mounted on a wiring substrate by using a reflow furnace. Terminals 4 can be made thicker than the caulked part 3 owing to the structure of the terminal shown in FIG. 4. As shown in FIGS. 6 and 7, the metallic mesh 13 for protecting the electrically conductive diaphragm may be omitted from the structure of the third embodiment as in the other embodiments described above. In the electret condenser microphones according to the embodiments described above except in the front-end one according to the first embodiment, the electret polymer film is only needed to be attached to one of the diaphragm and the fixed electrode, and the present invention is not limited to the embodiments described above.

### Fourth Embodiment

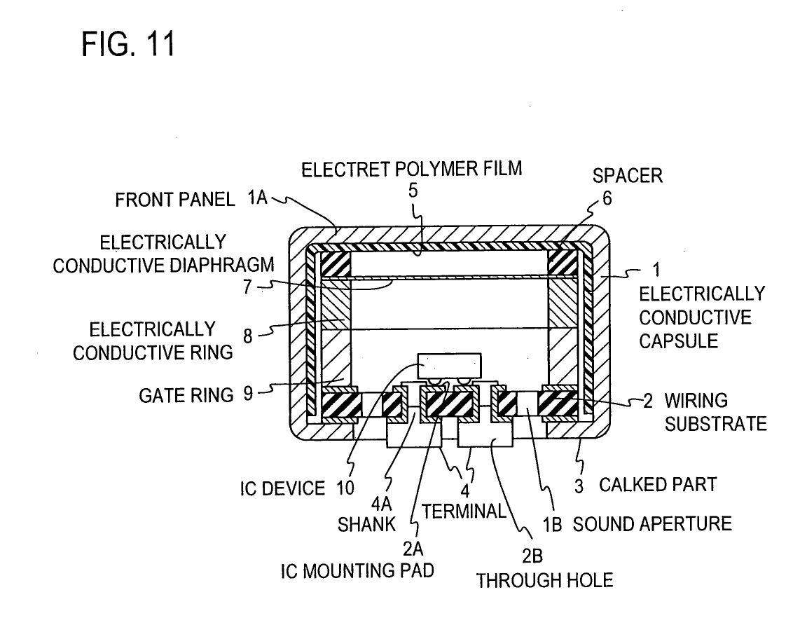

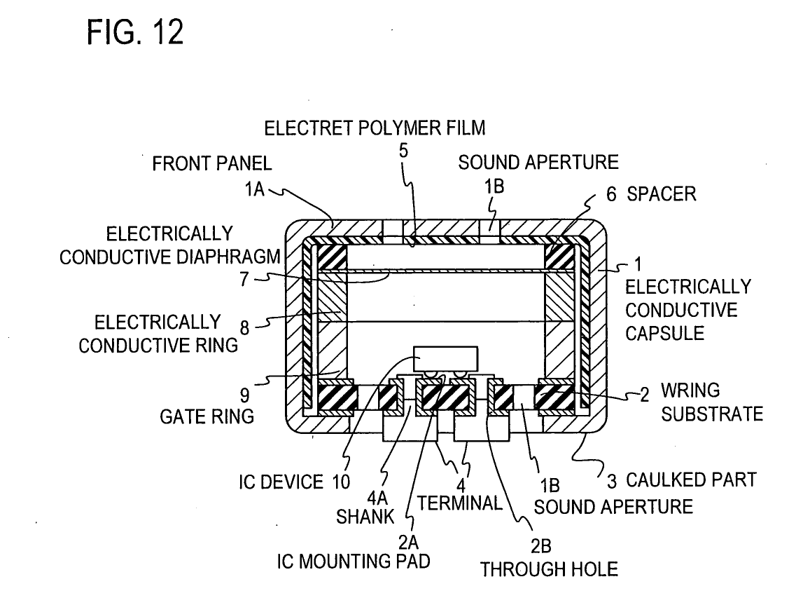

While sound apertures 1B are provided only on the front-panel 1A side of the electrically conductive capsule 1 in the first to third embodiments, sound apertures 1B may be formed in the wiring substrate 2 alone or may be formed in both of the front panel 1A and the wiring substrate 2, as shown in FIGS. 11 and 12.

A condenser microphone in which sound apertures 1B are formed only in the wiring substrate 2 (FIG. 11) is suitable for a case where the wiring substrate of an apparatus is positioned on the sound source side. In that case, sound apertures are formed also on the wiring substrate of the apparatus (not shown) in such a manner that they face the sound apertures 1B of the microphone.

A condenser microphone having sound apertures 1B formed on both of the front panel 1A of the electrically conductive capsule 1 and the wiring substrate 2 (FIG. 12) can be made as a bidirectional microphone.

While FIGS. 11 and 12 show front-type electret condenser microphones, electret condenser microphones of other types may have sound apertures 1 B formed only on their wiring substrates 2 or on both of the front panels 1A and wiring substrates 2.

### Fifth Embodiment

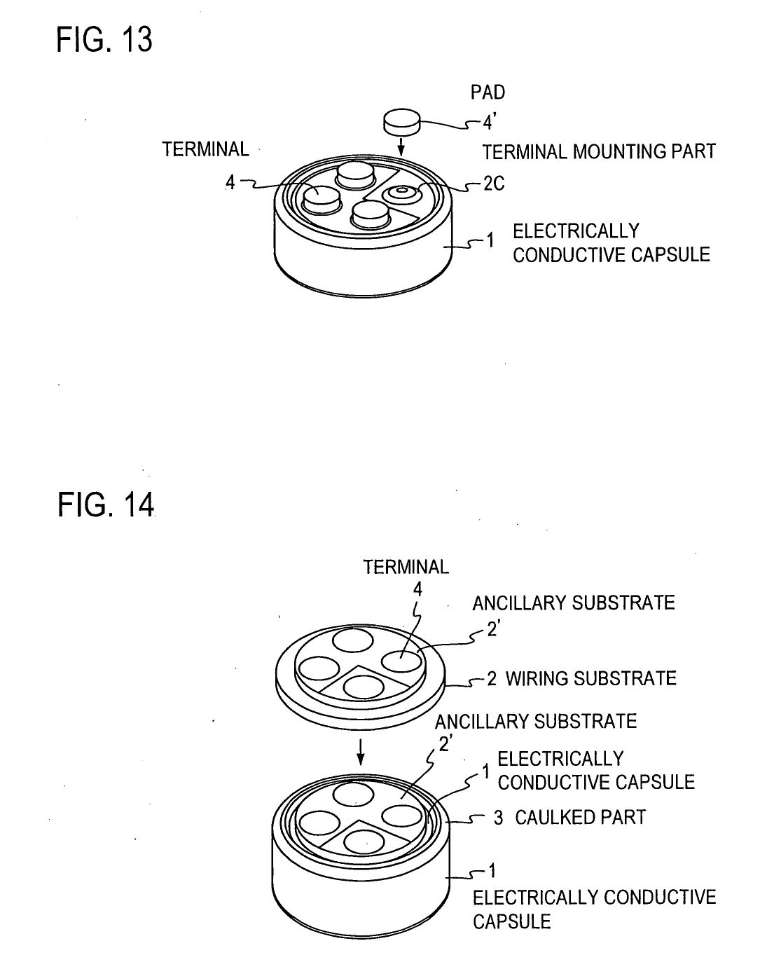

FIG. 13 shows an example in which disc-shaped pads are used as terminals. In this embodiment, a disc-shaped pad 4′ thicker than the electrically conductive plate of the electrically conductive capsule 1 is formed. The pad 4′ is then mounted on a terminal mounting portion 2C of a wiring substrate 2 to form a terminal 4.

### Sixth Embodiment

FIG. 14 shows an example in which an ancillary substrate 2′ is superimposed on a wiring substrate 2, thereby forming terminals 4 thicker than the electrically conductive plate of the electrically conductive capsule 1. The ancillary plate 2′ is a disc having a diameter smaller than the inner diameter of the rim of the electrically conductive capsule 1 with its open end being caulked. The terminals 4 are formed on the top surface of the ancillary substrate 2′ from a material such as a copper foil. The terminals 4 are electrically connected to the backside of a wiring substrate 2 through through holes provided in the ancillary substrate 2′ and the wiring substrate 2 and are then connected to terminal of an IC device 10.

In this structure, the ancillary substrate 2′ is formed thicker than the electrically conductive plate of the electrically conductive capsule 1 so that the terminals protrude outward beyond the height of the caulked part 3 of the electrically conductive capsule 1. This enables the electret microphone to be mounted on a wiring substrate of an apparatus by using a reflow furnace.

### Seventh Embodiment

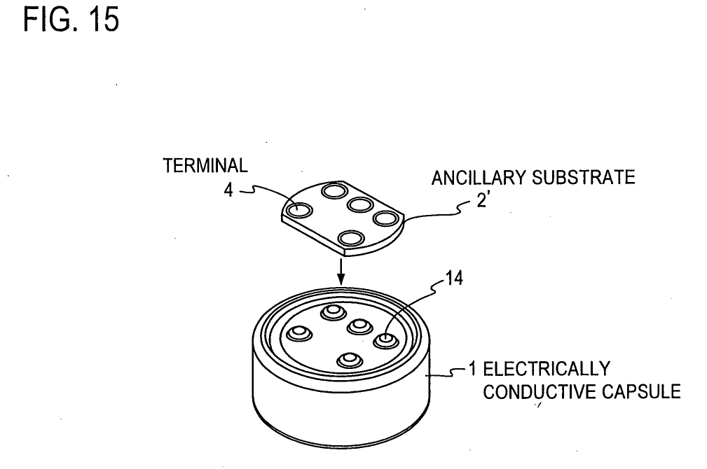

FIG. 15 shows another method for superimposing an ancillary substrate on a wiring substrate. In this method, solder 14 is built up at the position on a wiring substrate 2 that corresponds to each terminal. An ancillary substrate 2′ having through holes and terminals 4 in positions that coincide with the solder 14 is placed on the wring substrate 2. The solder 14 is then heated to melt it and the ancillary substrate 2′ is attached to the wiring substrate 2. The ancillary substrate 2′ may be attached to the wiring substrate 2 before or after the wiring substrate 2 is attached to the electrically conductive capsule 1.

Also in this embodiment, the ancillary substrate 2′ can be made thicker than the electrically conductive plate of the electrically conductive capsule 1 so that the terminals 4 formed on the top surface of the ancillary substrate 2′ protrude outward beyond the height of the caulked part 3 of the electrically conductive capsule 1. Therefore, the electret condenser microphone can be mounted on a wiring substrate of an apparatus by using a reflow furnace.

### Eighth Embodiment

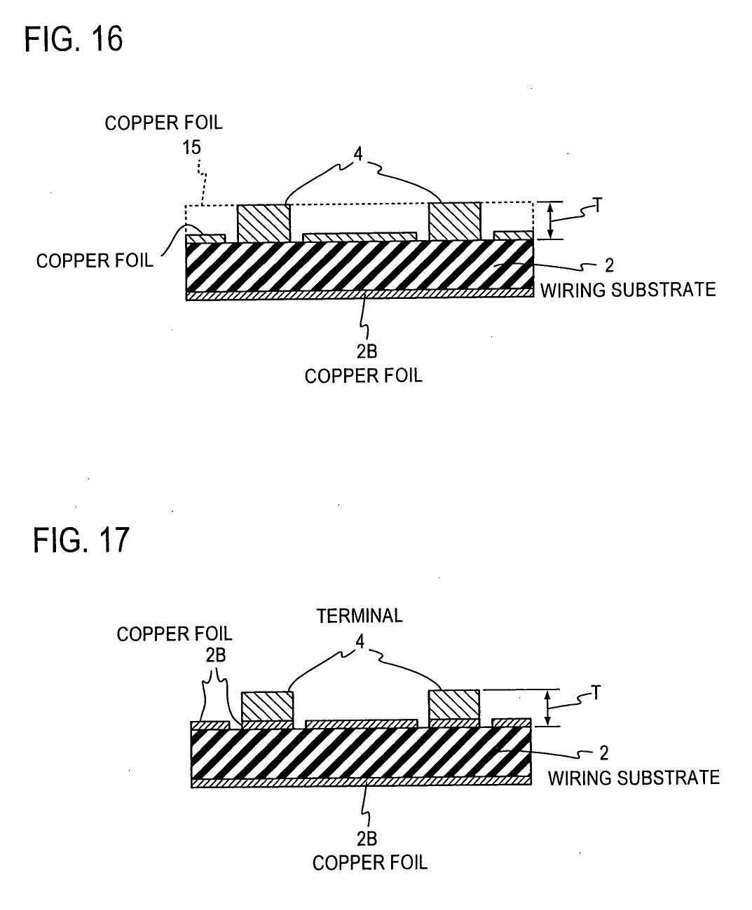

FIG. 16 shows a method for forming terminals 4 by etching. In this embodiment, the top surface of the wiring substrate 2 (that is exposed in the open end of an electrically conductive capsule 1) is covered with a copper foil 15 with a thickness equal to a required thickness T of the terminals 4. The positions of the terminals 4 on the top surface of the copper foil 15 are coated with a mask such as a photoresist. The remaining portions that are not coated with the mask are etched off. In this way, terminals 4 with the thickness T can be formed. Consequently, the electret condenser microphone can be mounted on a wiring substrate of an apparatus by using a reflow furnace.

### Ninth Embodiment

FIG. 17 shows a method for forming terminals 4 by plating. In this embodiment, a copper foil 2B in the positions where the terminals 4 are to be formed is left when the copper foil 2B on a wiring substrate 2 is etched off or otherwise removed. Copper plating is applied on the copper foil 2B that covers the positions of terminals 4 to form a plating layer with a predetermined thickness T. The plating layer is then formed as the terminals 4.

By any of the methods, the top surface of the terminals 4 can be protruded outward beyond the caulked part 3 by choosing the thickness T that is thicker than the electrically conductive plate of the electrically conductive capsule 1. Therefore, the electret condenser microphone can be mounted on a wiring substrate by using a reflow furnace.

What is claimed is:

1. An electret condenser microphone in which an open end of an electrically conductive cylindrical capsule having the other end being closed by a front panel is closed by a wiring substrate having an IC device mounted on one surface and terminals on the other surface;
an electrically conductive diaphragm and the front panel or a fixed electrode are provided at a predetermined distance apart from each other across a spacer in a space between the front panel and the wiring substrate; and
one of surfaces facing each other across the spacer is covered with an electret polymer film;
wherein:
the electret polymer film and the spacer are made of a heat-resistant material; and
sound apertures are formed in at least one of the front panel of the electrically conductive capsule and the wiring substrate.

2. The electret condenser microphone according to claim 1, wherein the spacer, the electrically conductive diaphragm, an electrically conductive ring holding the electrically conductive diaphragm, an electrically conductive gate ring, and the wiring substrate are disposed in this order starting from the front panel side; and
the inner surface of the front panel of the electrically conductive capsule is covered with the electret polymer film.

3. The electret condenser microphone according to claim 1, wherein:
the electrically conductive ring holding the electrically conductive diaphragm, the electrically conductive diaphragm, the spacer, the fixed electrode, an electrically conductive gate ring, and the wiring substrate are disposed in this order starting from the front panel side; and
one of the electrically conductive diaphragm and the fixed electrode is covered with the electret polymer film.

4. The electret condenser microphone according to claim 1, wherein:
the fixed electrode, the spacer, the electrically conductive diaphragm, the electrically conductive ring holding the electrically conductive diaphragm, an electrically conductive gate ring, and the wiring substrate are disposed in this order starting from the front panel side; and
one of the fixed electrode and the electrically conductive diaphragm is covered with the electret polymer film.

5. The electret condenser microphone according to claim 3, further comprising a metallic mesh provided on the inner surface of the front panel of the electrically conductive capsule.

6. The electret condenser microphone according to claim 4, further comprising a metallic mesh provide on the inner surface of the front panel of the electrically conductive capsule.

7. The electret condenser microphone according to claim 1, further comprising a heat-resistant cylindrical synthetic-resin member is provided between the inner peripheral surface of the electrically conductive capsule and components contained in the electrically conductive capsule.

8. The electret condenser microphone according to claim 1, wherein the wiring substrate is a double-sided wiring substrate and a plurality of terminals, including at least a power supply terminal, a digital signal output terminal, and a clock input terminal, are provided on the surface exposed in the open end of the electrically conductive capsule.

9. The electret condenser microphone according to claim 8, wherein the terminals protrude outward beyond a caulked part at the open end of the electrically conductive capsule.
